(19) United States
(12) Patent Application Publication
(10) Pub. No.: US 2016/0289104 A1
(43) Pub. Date: Oct. 6, 2016

(54) SYSTEM FOR TREATMENT OF FOOD PROCESS WASTE WATER

(71) Applicant: ClearCove Systems, Inc., Rochester, NY (US)

(72) Inventors: Jason E. Fox, Rochester, NY (US); Alfred Bertoni, Fairport, NY (US); Michael A. Butler, Webster, NY (US); Terry Wright, Rochester, NY (US)

(21) Appl. No.: 14/674,163

(22) Filed: Mar. 31, 2015

(51) Int. Cl. C02F 1/66; B01D 21/00; B01D 21/30; C02F 1/00

(52) U.S. Cl. CPC C02F 1/66; C02F 1/00; B01D 21/0018; B01D 21/302; B01D 21/305; B01D 21/307; C02F 2001/007; C02F 2103/32

(57) ABSTRACT

An apparatus and method for treatment of food process waste water, comprising a tank for receiving a food process waste water influent via an influent pump and discharging a treated food process waste water effluent via an effluent pump; a floating decanter disposed in the tank and operationally connected to the effluent pump; a valved outlet formed in the bottom of the tank; an upper level float switch operationally connected to the floating decanter and to the effluent pump; a lower level float switch operationally connected to the floating decanter and to the effluent pump; and a timer operationally connected to the floating decanter and the effluent pump. pH, BOD, and TSS may be adjusted. Solids are settled from the waste water and drawn off through the tank bottom after a supernatant is drawn off through the floating decanter.

### TECHNICAL FIELD

The present invention relates to systems for processing waste water; more particularly, to such systems for handling biologically digestible materials in waste water generated typically in foods and potables manufacturing and serving, e.g., bakeries, breweries, dairies, restaurants, wineries, and the like; and most particularly, to a simple, small volume system for settling solids and adjusting pH in food process waste water prior to discharging such waste water into a municipal sewage system.

As used herein, the term “food materials” should be taken to mean any and all biologically digestible organic materials, without limit; and the term “food process waste water” should be taken to mean excess water and by-products, components beyond just water itself, used in the manufacture and/or use of food materials that must be treated to remove a portion of the dissolved and/or suspended food materials before being either sent to a waste water treatment facility or otherwise discharged to the environment.

### BACKGROUND OF THE INVENTION

Foods and potables manufacturing and handling typically generate substantial levels of biologically digestible materials dissolved and suspended in their waste process water. Additionally, the pH of such waste water may be substantially acidic or alkaline. When directed without pre-treatment to municipal waste water treatment facilities, such waste water can place a heavy and costly treatment load on the facilities. As a result, many communities impose a substantial cost on companies that generate such waste waters in the course of their normal operations. It is known to monitor the level of food materials in waste water output of companies and to levy a sewer surcharge on the companies accordingly. Many of these companies, for example, “microbreweries”, are relatively small in capitalization and output and thus are in need of a relatively inexpensive method and associated apparatus for pre-treating of process waste water to remove a substantial percentage of suspended food materials therefrom before the process waste water is discharged to a municipal sewer system. Fortuitously, the total volume of process waste water generated by many such operations is relatively small, on the order of 1000 gallons/day or less, and therefore is amenable to treatment by a method and apparatus in accordance with the present invention.

Note: Biological Oxygen Demand (BOD, also known as Biochemical Oxygen Demand) is the amount of oxygen needed by aerobic microorganisms to decompose all the organic matter in a sample of water; it is used as a measure of pollution. As used herein, the term “BOD” also means more generally the unit volume load of such organic material in waste water.

Further, Total Suspended Solids (TSS) is a water quality measurement which, as used herein, is expressed as the unit volume load of suspended solids in water. It is listed as a conventional pollutant in the U.S. Clean Water Act.

### EXAMPLE

The following example is directed to the characteristics and treatment of waste water generated by breweries. It should be understood that the disclosed method and apparatus are also well-suited to similar usage in many other types of food manufacturing and use as noted above.

Breweries have unique effluent characteristics and specific treatment needs. Breweries typically have Biological Oxygen Demand (BOD) levels of 2,000-4,000 mg/l and Total Suspended Solids (TSS) levels of 2,500-3,500 mg/l. The solids are fairly heavy and easy to settle out, and much of the dissolved organic load can also be precipitated out by dosing the waste water with coagulants. Brewery effluent has a pH range of 4-9, depending on what process is taking place in the brewery. The pH may have to be adjusted on occasion to meet municipal requirements. Brewery effluent can have fluctuating levels of BOD, TSS and pH. There is also a chance that occasionally the brewery may have to waste a batch of beer, discharging the batch and introducing high levels of BOD into a municipal system.

Brewery waste water comprises several contributors to the total BOD and TSS load. Most of these are organic in nature and pose no serious threat to public health.

Yeast, spent grain, and hops are the building blocks of beer. Most of the waste from these components typically are side streamed in the brewery and diverted as feed for farm animals. Inevitably, some of that waste also will get down the drain and thereby raise the BOD and TSS levels of the effluent.

Wort is the liquid that will become beer once the yeast is added. Wort comprises fermentable and unfermentable sugars as well as starches and proteins. Because wort is rich in dissolved sugar, it is the primary contributor of BOD and SBOD (soluble BOD).

Fermented beer left in tanks after transfers and lost during packaging will also contribute to the BOD and SBOD of the effluent leaving the brewery.

Beer has a charcteristically low pH (typically 4-5.5) that will reduce the overall pH of the waste water.

For cleaning chemicals, breweries typically rely on caustic solutions for removing organic deposits from their process tanks. Acid is used on occasion, as are iodine-based sanitizers and peracetic acid for sanitizing tanks and equipment. These are diluted when used, but will still affect the pH of the final effluent.

Most of the water used by breweries leaves in the form of finished beer, so daily flows are relatively low and comprise mostly cleaning water. A typical microbrewery may generate no more than about 200-300 gallons of process waste water per day, although naturally that volume will grow as production volumes grow.

What is needed is an appropriately-sized but scalable, relatively inexpensive waste water settling system for removing biologically-digestible solids from food process waste water.

### SUMMARY OF THE INVENTION

Briefly described, a system in accordance with the present application comprises a pretreatment system to intercept and treat a process waste water effluent stream before it enters the municipal sanitary system. Systems in accordance with the present invention can be scaled up or down to meet the needs and economic price point of even small operations/companies, and can then be readily scaled up as treatment demand increases.

The present system pumps the effluent stream from a user's trench drains or a sump into a holding tank for settling and for pH or dissolved solids adjustment. A sump pump is responsive to a signal such as a float switch in the user's sump or drainage trench. The tank has a conical bottom with a manual discharge valve for removal of settled solids. The system has a chemical dosing mechanism to permit effluent adjustment. The supernatant is decanted from the top down using a floating decanter, following a predetermined settling period. The decanter is equipped with a float switch to automatically activate it when a certain level in the tank is reached, to prevent overfilling the tank. Alternatively or in addition, a standpipe connected to drain may be incorporated into the tank to guard against accidental overfilling and spillage. The discharge pump is equipped with a timer that can be set to drain the tank slowly after a pre-set settling period time to reduce the load on the municipal sanitary system. Preferably, a solenoid valve also controlled by the timer is disposed in the drain line to prevent inadvertent siphoning of the tank via the floating decanter.

In operation, many beneficial users bf the present system have manufacturing operations that generate waste water only during the daytime. Thus, in an anticipated operating protocol the tank is filled progressively with food process waste water during the work day. Waste water pH and/or other characteristic may also be adjusted as needed. Settling of solids occurs during the nighttime hours when the waste water is tranquil, followed by decanting of the cleared supernatant effluent from the tank before the start of the next work day, after which the accumulated solids are also drawn off through the valve in the bottom of the tank for landfill, bio-digestion, or other disposal.

### BRIEF DESCRIPTION OF THE DRAWINGS

The present invention will now be described, by way of example, with reference to the accompanying drawings, in which:

FIG. 1 is a schematic drawing of an elevational cross-sectional view of a first embodiment of a primary treatment settling tank system in accordance with the present invention; and

FIG. 2 is a plan view of a portion of the primary treatment settling tank system shown in FIG. 1.

The exemplification set out herein illustrates a currently preferred embodiment of the invention, and such exemplification is not to be construed as limiting the scope of the invention in any manner.

### DESCRIPTION OF THE PREFERRED EMBODIMENTS

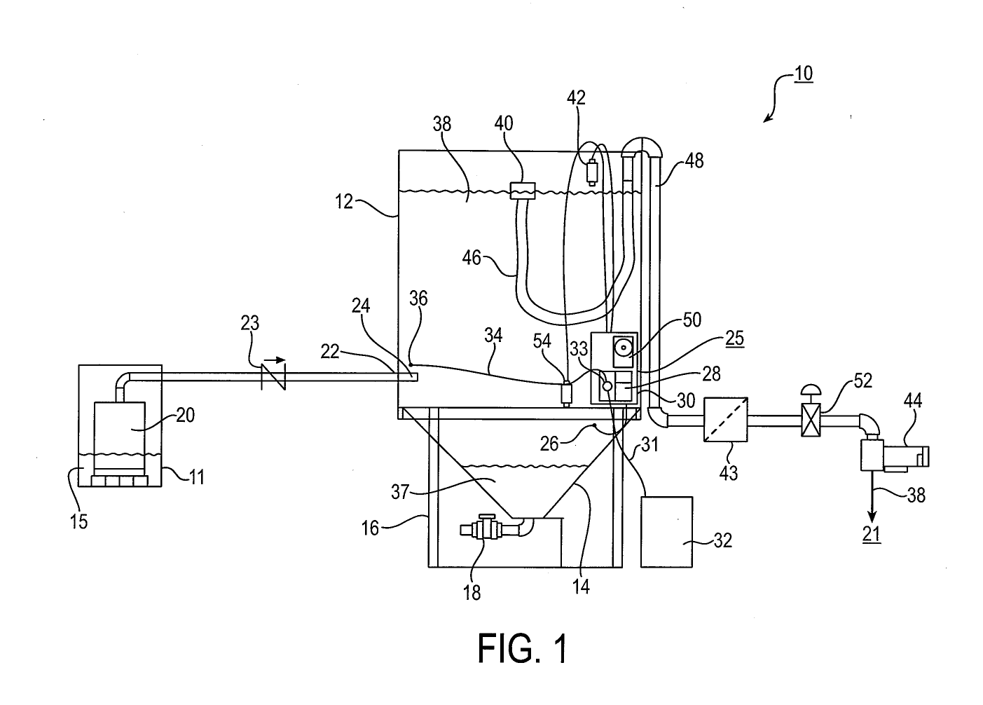

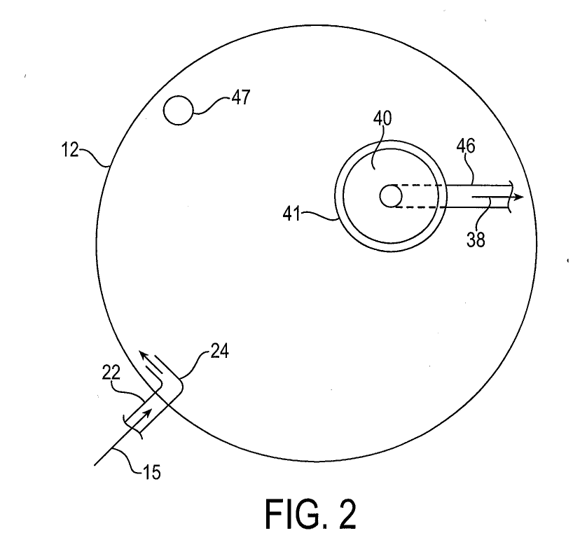

Referring now to FIGS. 1 and 2, a system 10 for treatment of food process waste water is shown. System 10 comprises an elevated tank 12, e.g., a cylindrical 1000 gallon tank formed, e.g., of polyethylene or polypropylene or stainless steel or other material able to tolerate caustic by-product of food processing. Tank 12 includes hopper bottom 14, preferably conical as shown, and is mounted on a stand 16 providing access to a solids outlet valve 18 in hopper bottom 14.

Preferably, tank 12 is sized to hold and dilute an entire spoiled batch (e.g., of beer or wine) and, additionally, one day or more of process discharge. This allows the user to treat and dilute spikes in process discharge constituents, e.g., BOD, TSS, and/or pH. Untreated food process waste water effluent (tank influent) 15 from a user's trench drain or sump 11 flows into tank 12 via a conventional sump pump 20 and backflow preventer check valve 23. System 10 is functionally positioned in the user's waste water effluent line between user's sump 11 and a municipal sanitary sewer 21. Preferably, the tank influent connection 22 to tank 12 is, for example, PVC pipe, and is located in the cylindrical tank wall near the transition to conical hopper bottom 14 and includes a 90° elbow 24 to turn the flow within the tank substantially parallel to the tank wall to cause circular circulation of influent within the tank.

Conical hopper bottom 14 has an included cone angle selected from the group of cone angles consisting of at least 45°, 60°, and all angles therebetween.

System 10 includes a chemical dosing mechanism 25 that displays at least one chemical characteristic of interest in the influent and allows adjustment of that characteristic of the influent by addition of dosing chemicals, for example, alkali or acid to bring the pH into the required range before discharging of treated effluent. The chemical dosing mechanism includes a dosing pump probe 26 disposed within tank 12, preferably about five inches below the top of bottom 14. Probe 26 is connected to a pH controller and dosing pump 28 disposed in a control box 30. Dosing pump 28 is supplied with a dosing chemical via a first dosing hose 31 from a reservoir 32. The dosing chemical is injected via a tank valve 33 and second dosing hose 34 into supernatant 38 at location 36, preferably at a point about two inches above elbow 24.

For further BOD and TSS reduction, chemical coagulants (e.g., ACH, PAC,) can be dosed to the fluid in the tank specifically to reduce soluble BOD. Preferably, this is done at the end of each day of production to allow the maximum number of hours for settling of solids 37. Dosing rates are very low (generally 100-150 ppm) and have no adverse effect on the waste water stream.

During a predetermined settling period, the food process waste water is gravitationally separated into a settled solids fraction 37 and a supernatant fraction 38. Supernatant 38 is decanted from the top down using a decanter 40, preferably a floating decanter. Decanter 40 is equipped with an upper float switch 42 to automatically activate floating decanter 40 when a pre-set alarm level of supernatant 38 in tank 12 is reached. This prevents accidental overfilling and spilling of the tank. Optionally, a conventional standpipe 47 also may be installed in tank 12 in addition to decanter 40 and connected to sewer 21.

Decanter 40 may be equipped with a first, coarse filter 41 disposed in the flow stream through decanter 40, either before or after the lip of the decanter, and may be further equipped with a second, fine filter 43 to further reduce the suspended BOD of supernatant effluent 38 being sent to municipal sanitary sewer 21. Preferably at least fine filter 43 is embodied as a simple cartridge filter that is readily replaced when system 10 is empty prior to beginning another daily process cycle.

Discharge pump 44 is connected to decanter 40 via flex hose 46 and rigid PVC pipe 48. System 10 includes a multiple-setting timer 50 connected to a normally-closed solenoid valve 52 and effluent pump 44 that can be set for intermittent flow from tank 12, to drain the tank slowly over time to further reduce the instantaneous load on the municipal waste water treatment plant. The cycles can be determined by the operator and the municipality. If tank 12 fills completely, upper float switch 42 activates floating decanter 40, solenoid valve 52, and effluent pump 44 to pump just enough effluent from the tank to bring the level down to a safe operating level. Optionally, decanter 40 is fitted with filter 41, and optionally the effluent discharge line 48 is configured with filter 43.

In one anticipated mode of operation of system 10, daytime operations cease between approximately 8:00 pm and 6:00 am, giving system 10 enough time to allow settling of solids and then to empty itself before the start of the next production day. When the level of supernatant 38 reaches lower float switch 54, floating decanter 40, solenoid valve 52, and effluent pump 44 are deactivated. After tank 12 is emptied, an operator drains the settled solids from the conical bottom 14 of tank 12 at the start of each day of production.

In many applications equipped in accordance with the present invention, some solids and other contributors of BOD can be collected, or “side-streamed”, from the various point sources of discharge throughout the facility, and can be captured in, for example, nylon filter bags. This can reduce significantly the amount of solids entering system 10 and can lower the total BOD level as well.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for treatment of food process waste water, comprising:
a) a tank for receiving a food process waste water influent and discharging a treated food process waste water effluent;
b) an influent pump for delivering said food process waste water influent to said tank;
c) an effluent pump for discharging said treated food process waste water effluent from said tank;
d) a decanter disposed in said tank and operationally connected to said effluent pump and variable in vertical position within said tank responsive to changes in level of said food process waste water;
e) a valved outlet formed in the bottom of said tank;
f) an upper level float switch operationally connected to at least said effluent pump;
g) a lower level float switch operationally connected to at least said effluent pump; and
h) a timer operationally connected to at least said effluent pump.

2. A system in accordance with claim 1 wherein said bottom is conical in shape.

3. A system in accordance with claim 2 wherein the included angle of said conical bottom is not less than 45°.

4. A system in accordance with claim 2 wherein the included angle of said conical bottom is 60°.

5. A system in accordance with claim 1 further comprising a chemical dosing system.

6. A system in accordance with claim 5 wherein said chemical dosing system comprises a reservoir, a dosing pump hydraulically connected to said reservoir, and a sensor disposed in said tank and operationally connected to said dosing pump.

7. A system in accordance with claim 6 further comprising a dosing valve operationally connected to said dosing pump.

8. A system in accordance with claim 1 further comprising a normally-closed solenoid valve operationally connected to said effluent pump and said timer.

9. A system in accordance with claim 1 wherein said decanter is a floating decanter.

10. A method for treating an effluent stream of food process waste water, comprising the steps of:
a) providing a tank for receiving and treating said effluent stream;
b) receiving a volume of said food process waste water in said tank;
c) allowing said received volume of food process waste water to stand in said tank without agitation for a predetermined period of time, to cause gravitational settling of suspended solids in said food process waste water into a settled solids fraction and a supernatant fraction;
d) drawing off said supernatant fraction from the upper surface of said supernatant fraction after said predetermined period of time; and
e) drawing off said settled solids fraction from a lower surface of said settled solids fraction.

11. A method in accordance with claim 10 comprising the further step of adjusting at least one characteristic of said influent food process waste water within said tank.

12. A method in accordance with claim 11 wherein said at least one characteristic is selected from the group consisting of pH, BOD, SBOD, and TSS.
